(19) United States
(12) Patent Application Publication
(10) Pub. No.: US 2023/0298352 A1
(43) Pub. Date: Sep. 21, 2023

(54) REMOTE SENSING SECURITY AND COMMUNICATION SYSTEM

(71) Applicant: Meta Platforms Technologies, LLC, Menlo Park, CA (US)

(72) Inventors: Zhisheng YUN, Sammamish, WA (US); Brendan HAMEL-BISSELL, Bellevue, WA (US); Fei LIU, Los Altos, CA (US)

(73) Assignee: Meta Platforms Technologies, LLC, Menlo Park, CA (US)

(21) Appl. No.: 17/696,571

(22) Filed: Mar. 16, 2022

(51) Int. Cl. G06V 20/52; G06T 7/20; H04N 5/225; G06V 10/143; G06V 10/147; H04N 7/18; G06V 10/70; G08B 13/19; G02B 27/12; G02B 27/10

(52) U.S. Cl. CPC G06V 20/52; G06T 7/20; H04N 5/2258; H04N 5/2254; H04N 5/2253; G06V 10/143; G06V 10/147; H04N 7/181; G06V 10/70; G08B 13/19; G02B 27/126; G02B 27/1013; G06T 2207/30232; G06T 2207/10048; G06T 2207/20081; H04L 67/12

(57) ABSTRACT

According to examples, a remote sensing security system that includes a dual-purpose camera system comprising at least one dual-purpose camera is disclosed. The dual-purpose camera may include a visible light sensor that detects one or more of objects and movements in the visible spectrum and an infrared (IR) sensor that detects one or more of objects and movements in the IR spectrum. The data from the dual-purpose camera system may be transmitted to a cloud server which may process the data to identify the detected objects and/or movements. If any objects and/or movements related to an emergency to are identified, then the type of emergency may also be determined and alerts may be transmitted to one or more client devices which may include head-mounted display (HMD) devices.

### TECHNICAL FIELD

This patent application relates generally to remote sensing display systems, and more specifically, to remote sensing security and communication systems that include dual-purpose visible and infrared (IR) based camera systems to monitor premises and generate alerts in case of emergencies.

### BACKGROUND

Video surveillance systems use one or more cameras to monitor indoor premises and/or outdoor spaces to detect various activities. These may range from package deliveries to intruders. With burgeoning advancements in data communications, camera and sensor technologies, and augmented reality (AR), virtual reality (VR), and mixed reality (MR) devices, a more robust and comprehensive video surveillance system may be provided.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 shows a block diagram of a remote sensing security system, according to an example.

FIG. 2 shows a block diagram of a user device that may form a part of a dual-purpose camera system, according to an example.

FIG. 3 shows a block diagram of a cloud server, according to an example.

FIG. 4A shows a diagram of an optical system that may be included in the dual-purpose camera system, according to an example.

FIG. 4B shows a figure of a beam split cube that may be included in the optical system, according to an example.

FIG. 5 shows a flowchart of a method for remotely monitoring a location, according to an example.

FIG. 6 illustrates a block diagram of a computer system for securing a remote building, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Surveillance systems may generally include two types of video cameras—analog cameras such as those that may be used in closed-circuit TV (CCTV) systems or digital cameras used in conjunction with internet protocol (IP) networks. Different types of video surveillance services, including Video Surveillance as a Service (VSaaS) and hybrid-hosted solutions, may be offered by different providers. While some solutions may include installation of the video equipment and the surveillance occurring at the same site, many modern services may offer remotely monitored video surveillance, which may also be referred to as “network video surveillance.” It is a term used to describe a setup wherein a physical location is monitored remotely from another geographical location. Again, different types of video cameras may also be employed for different types of surveillance. Some video cameras may record continuous video while other types of video cameras may record time-lapse footage on detected movements with motions sensors.

The systems and methods described herein may be directed to a remote sensing security system for remotely monitoring a location or premises. In some examples, the remote sensing security system may include a dual-purpose camera system that has at least one dual-purpose camera with a visible light sensor and/or an infrared (IR) sensor. The visible light sensor may detect objects and/or movements in the visible spectrum whereas the IR sensor may detect objects and/or movements in the IR spectrum.

In some examples, the remote sensing security system may also include a server, such as a cloud service. The data from the dual-purpose camera system, for example, may be provided to a cloud server, for analysis and/or detection of any emergency conditions at the monitored location or premises. In an example, the cloud server may be located in a remote geographic location from the monitored premises. In some examples, the cloud server may include machine learning (ML) based object detection models, which when used in conjunction with one or more computer vision techniques, for detecting various objects, such as humans, animals, nonliving objects, and/or conditions that may be indicative of an emergency on the premises. If no, objects, movements, and/or conditions can be detected, then the cloud server may determine that there is no emergency at the premises.

In an example, the data from the dual-purpose camera system may be analyzed in one or more stages for a confirmed identification of the type of emergency. For example, the data from the visible sensor may be initially analyzed for object identification and/or for determining the type of emergency. In the event objects identified, by the system, in the visible spectrum data are indicative of a potential fire emergency, then the data from the IR sensor, which may sense or detect thermal signals, may be further analyzed for confirmation of the fire emergency.

Once such an emergency is detected and identified, various actions for dealing with the fire emergency may be executed by the cloud server. For example, these actions may include transmitting one or more notifications to one or more client devices registered with the cloud server to receive notifications related to the particular premises. For fire emergencies, additional notifications, such as to the fire department may also be transmitted. In some examples, the the one or more client devices may be a mobile phone or an AR/VR device capable of providing to the one or more notifications to a user in real-time or near real-time. Other various non-fire related emergencies, e.g., intruders, water leakage, etc., may also be detected and/or identified by the remote sensing security system as described herein. In such cases, the cloud server may be configured to execute one or more actions, such as transmitting one or more notifications to any number of registered client devices.

In some examples, the registered client devices may include, but not limited to, mobile computers, tabliets, phones, watches, or other similar portable device capable of transmitting and receiving data signals. In some examples, the registered client device may also include a head-mounted display (HMD) device, such as an augmented reality (AR) eyewear or glasses. If no objects are detected, the cloud server may determine that there is no emergency at the premises and may continue to monitor the premises by receiving data periodically or continuously from the dual-purpose camera system.

The remote sensing security system as described herein may also include a dual-purpose camera system that includes at least two dual-purpose cameras for surveillance at a premises. In this example, there may be at least an indoor dual-purpose camera to monitor the indoors of a building that may be located on the premises and at least one outdoor dual-purpose camera may monitor the outdoors of the building. The indoor dual-purpose camera may be communicatively coupled to the outdoor dual-purpose camera to form a network that communicates with the cloud server. Alternatively or additionally, the various dual-purpose cameras of the dual-purpose camera system may be individually coupled to the cloud server so that each dual-purpose camera may independently communicate the generated data to the cloud server. In an example, the indoor dual-purpose camera may form part of a device such as a tablet device, a laptop, a desktop, etc., which in turn may be communicatively coupled to the cloud server. Other various configurations may also be provided.

Each dual-purpose camera may be configured with a compact optical design that may accommodate at least two sensors that may function in different portions of the electromagnetic spectrum. An imaging lens may be included in the dual-purpose camera for capturing the light rays that may be focused on a beam split cube. In an example, the imaging lens may comprise multiple imaging lenses. The beam split cube may include a surface coated so that an IR component of light beam incident of the coated surface may be reflected and the visible light competent of the incident light beam may be transmitted. A visible light sensor may be arranged behind the beam split cube to receive the visible light competent and an IR sensor may be arranged below the beam split cube to receive the reflected IR component of the incident beam. An additional lens may be attached between the beam split cube and the IR sensor to generate a sharper IR image.

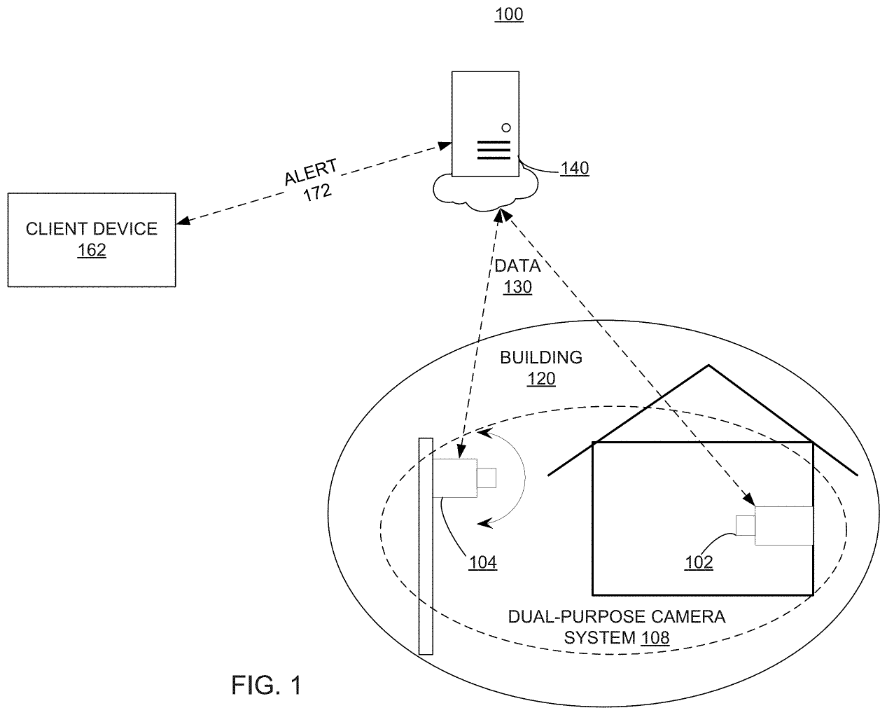

FIG. 1 shows a block diagram of a remote sensing security system 100 according to an example. The system 100 may include at least one dual-purpose camera system 108 that may monitor a premises e.g., a building 120, and may transmit the data 130 including video data to a cloud server 140. The cloud server 140 may process the data 130 to determine if there is an emergency at the premises. If the cloud server 140 determines that an emergency exists at the building 120, then alert(s) 172 regarding the emergency may be transmitted to at least one client device 162. In an example, the dual-purpose camera system 108 may include at least two dual-purpose cameras-an indoor dual-purpose camera 102 and an outdoor dual-purpose camera 104 installed on the building 120. The indoor dual-purpose camera 102 may sense or record conditions inside the building 120 while the outdoor dual-purpose camera 104 may record and transmit data regarding conditions outside the building 120. Each of the dual-purpose cameras 102 and 104 may be built with sensors to detect objects or movements in different spectra such as the visible spectrum and the infrared (IR) spectrum.

The dual-purpose cameras 102 and 104 may be continuously monitoring the interior and the exterior of the building 120. In an example, the dual-purpose cameras may be communicatively coupled to form a local network which in turn may be connected to the cloud server 140 via the internet. In an example, each of the dual-purpose cameras 102 and 104 may be individually connected to the cloud server 140 via the internet. In an example, one or more of the dual-purpose cameras 102 and 104 may be associated with or included as part of a user device such as a desktop, a laptop, or a tablet device (not shown) which may form part of the dual-purpose camera system 108. The user device may in turn be connected to the cloud server 140 via the internet.

The image/video data 130 from the dual-purpose camera system 108 may be continuously, discontinuously, or periodically received at the cloud server 140 wherein it may be analyzed for identification of specific objects and/or movements. The cloud server 140 may be configured to identify specific objects and in response to identifying the specific objects, the cloud server 140 may be further configured to trigger notifications or alerts 172 to at least one client device 162 which may be disparate and/or remote from the dual-purpose cameras 102, 104. The client device 162 may include but is not limited to one or more of smartphones, smartwatches, HMDs which may include Augmented Reality (AR), Virtual Reality (VR), or Mixed Reality (MR) devices. The remote sensing security system 100 described above may be configured to monitor the building 120 for safety and security issues. Although only two dual-purpose cameras are illustrated, it may be appreciated that any number of dual-purpose cameras may be similarly installed and communicatively coupled to each other and/or the cloud server 140 to enable monitoring of the building 120 remotely by the cloud server 140.

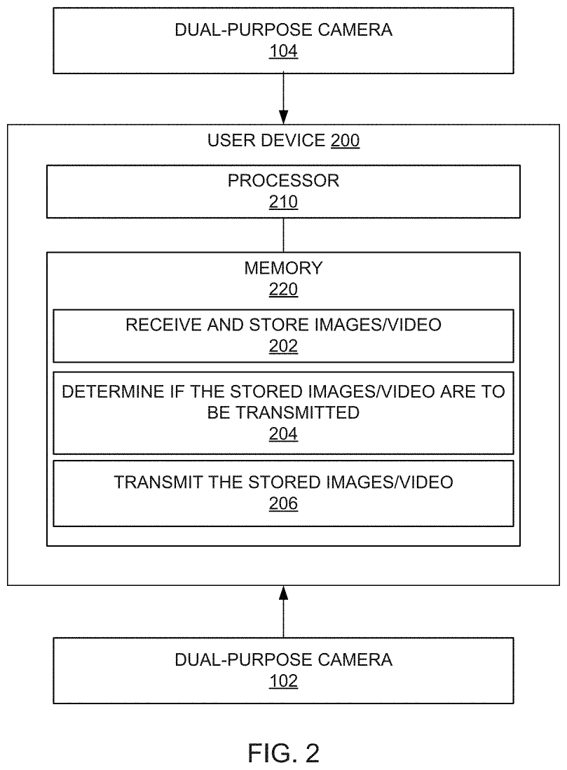

FIG. 2 shows a block diagram of a user device 200 that may form a part of the dual-purpose camera system 108 and may include onboard one of the dual-purpose cameras e.g., the indoor dual-purpose camera 102. Alternately the user device 200 may be communicatively coupled to both the dual-purpose cameras 102, 104 according to an example. In an example, the dual-purpose camera 102 may also include a processor 210, a non-transitory storage medium 220, and a communication interface (not shown) to record and transmit video data. Among other components and hardware, the user device 200 may also include a dual-purpose camera (e.g., the indoor dual-purpose camera 102). In addition, the memory 220 may include instructions that may be executed by the processor 210 to carry out certain tasks.

It should be appreciated that the processor 210 may be a semiconductor-based microprocessor, a central processing unit (CPU), an application specific integrated circuit (ASIC), a field-programmable gate array (FPGA), and/or other suitable hardware device. In some examples, the memory 220 may have stored thereon machine-readable instructions (which may also be termed computer-readable instructions) that the processor 210 may execute. The memory 220 may be an electronic, magnetic, optical, or other physical storage device that contains or stores executable instructions. The memory 220 may be, for example, Random Access Memory (RAM), an Electrically Erasable Programmable Read-Only Memory (EEPROM), a storage device, an optical disc, and the like. The memory 220, which may also be referred to as a computer-readable storage medium, may be a non-transitory machine-readable storage medium, where the term “non-transitory” does not encompass transitory propagating signals.

The processor 210 may execute instructions 202 to receive and store images/video recorded by the dual-purpose camera(s) 102 and optionally dual-purpose camera 104 in case the dual-purpose camera 104 is a stand-alone camera capable of being communicatively coupled to the user device 200. The processor 210 may execute instructions 204 to determine that the stored video/image may be transmitted to the cloud server 140 as data 130. In an example, the user device 200 may be configured to periodically transmit the data 130 to the cloud server 140 as push notifications. In an example, the cloud server 140 may pull the data 130 from the user device 200. In either case, the processor 210 may execute instructions 206 to transmit the images/video to the cloud server 140 whenever it is determined that the images/video are to be transmitted.

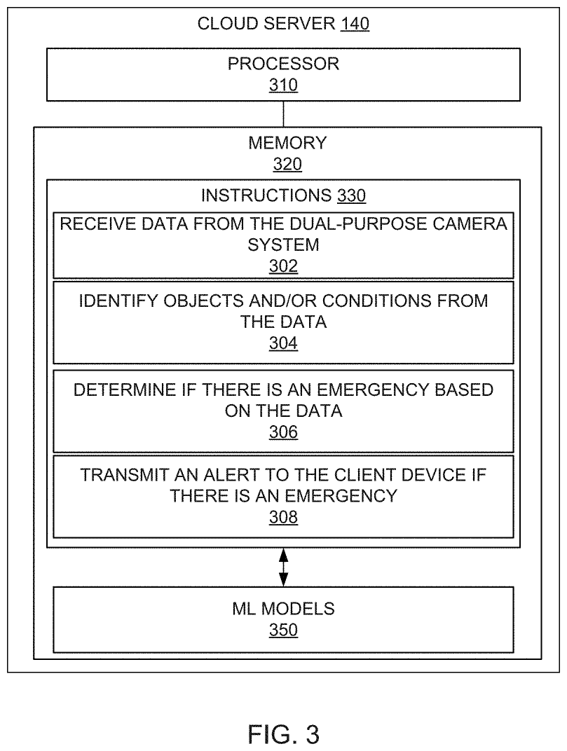

FIG. 3 shows a block diagram of the cloud server 140 according to one example. The cloud server 140 may also include a processor 310 and a memory 320 that may include instructions 330 that may be executed by the processor 310 to carry out certain tasks. It should be appreciated that the processor 310 may be a semiconductor-based microprocessor, a central processing unit (CPU), an application specific integrated circuit (ASIC), a field-programmable gate array (FPGA), and/or other suitable hardware device. In some examples, the memory 320 may have stored thereon machine-readable instructions (which may also be termed computer-readable instructions) that the processor 310 may execute. The memory 320 may be an electronic, magnetic, optical, or other physical storage device that contains or stores executable instructions. The memory 320 may be, for example, Random Access Memory (RAM), an Electrically Erasable Programmable Read-Only Memory (EEPROM), a storage device, an optical disc, and the like. The memory 320, which may also be referred to as a computer-readable storage medium, may be a non-transitory machine-readable storage medium, where the term “non-transitory” does not encompass transitory propagating signals.

The memory 320 may include instructions 302 to receive the data 130 including the images/video from the dual-purpose camera system 108. The instructions 302 may cause the processor 310 may pull the data 130 from the dual-purpose camera system 108 periodically. Alternatively or additionally, the instructions 302 may cause the cloud server 104 to receive the data 130 when it is pushed to the cloud server 140. The data 130 provided to the cloud server 140 may not only include images/video in the visible spectrum but may also include images from the IR spectrum.

While the images in the visible spectrum enable identifying nonliving and living objects, the images in the IR spectrum may enable confirming the type of emergency at the building 120 based on the objects identified from the data 130. Accordingly, the processor 310 may execute instructions 304 to identify objects and/or conditions from the data 130. In an example, machine learning (ML) based models 350 pre-trained to identify specific objects/conditions such as but not limited to, fire, smoke, living beings, etc. may be employed for object detection and identification. In an example, the data 130 may include both visible spectrum data as well as data from the IR spectrum. Although ML models 350 are shown as being stored in the memory 320, it may be appreciated that the ML models 350 may even be stored remotely from the cloud server 140 and may yet be accessed by the processor 310 for object recognition. Infrared imaging-based machine vision technology may be used to automatically inspect, detect and analyze infrared images (or videos) obtained from the dual-purpose camera system 108.

The processor 310 may execute instructions 306 to determine if an emergency exists at the building 120. An identification (i.e., having a confidence level greater than a predetermined threshold) may be made by one or more of the ML models 310 to cause the instructions 306 to determine that an emergency exists. If, on the other hand, no positive identifications are made from the data 130 received from the dual-purpose camera system 108, then it may be determined that no emergency exists at the building 120 and the data 130 may be ignored and/or stored in archives. If it is determined that there is an emergency at the building 120, the processor 310 may execute instructions 308 to transmit an alert 172 to the client device 162. In an example, the alert 172 may include the images and/or video from the data 130.

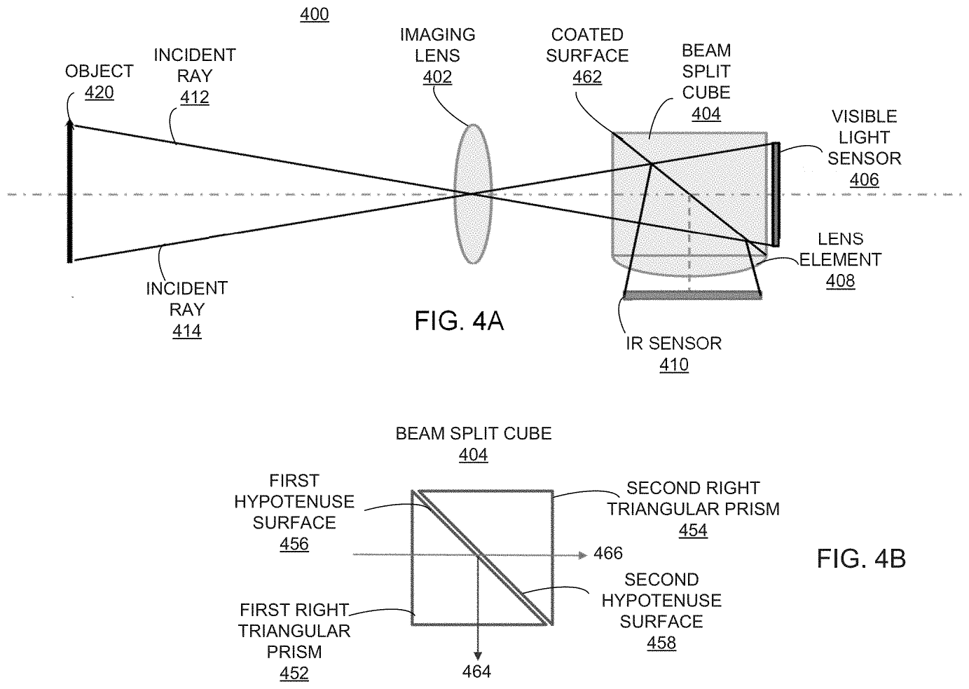

FIG. 4A shows a diagram of an optical system 400 and FIG. 4B shows a beam split cube that may be used in the optical system 400 according to an example, The optical system 400 may be included in one or more of the indoor dual-purpose camera 102 and the outdoor dual-purpose camera 104 for recording images in the visible spectrum and the IR spectrum accordingly to an example. The optical system 400 may include an imaging lens 402, a beam split cube 404, a visible light sensor 406, a lens element 408 attached to the beam split cube 404, and an IR sensor 410. The imaging lens 402 is arranged in front of the beam split cube 404. The imaging lens 402 is configured to capture the incident rays 412 and 414 of an object 420 to form an image on the visible light sensor 406. However, the beam split cube 404 includes a coated surface 462 that may be configured to transmit visible light and reflect IR radiation. In some examples, materials used for coating may include, without limitation, silicon dioxide (SiO₂), titanium dioxide or titania (TiO₂), magnesium flouride (MgF₂), alumina or aluminum oxide (Al₂O₃), magnesium oxide (MgO), mickel oxide (NiO), silicon monoxide (SiO), tantalum pentoxide (Ta₂O₅), zinc sulphide (ZnS), titanium monoxide (TiO), etc.

As shown in FIG. 4B, the beam split cube 404, in some ecxamples, may be composed of two 45 degree right-triangular prisms, a first right-triangular prism 452 and a second right-triangular prism 454. In an example, the beam split cube 404 may be larger than the visibie light sensor 406. A first hypotenuse surface 456 of the first right-triangular prism 452 or a second hypotenuse surface 458 of the second right-triangular prism 454 may form a coated surface 462. In an example, the IR beam 464 may be reflected by the first hypotenuse surface 456 or the second hypotenuse surface 458, depending on whichever surface bears the coating thereon.

As a result splitting of the incident ray 412 by the beam split prism 404, a visible image of the object 420, for example, may be formed on the visible light sensor 406 from the visible light component of the incident rays 412 and 414. The IR portion of the incident rays 412 and 414 may be split up by the coated surface 462 to be reflected onto the lens element 408. The reflected IR component may be rendered parallel by the lens element 408 to form a sharp IR image on the IR sensor 410. The coated surface 462 may be arranged at such a distance from the lens element 408 that a beam of the IR spectrum is made to be incident on the IR sensor 410. The image information from the visible light sensor 406 and the IR sensor 410 may be provided as the data 130 to the cloud server 140. The optical system 400, therefore, affords a compact optical design and configuration for the dual-purpose cameras to be used in the dual-purpose camera system 108.

The method detailed in the flowchart below is provided by way of an example. There may be a variety of ways to carry out the method described herein. Although the method detailed below are primarily described as being performed by cloud server 140, as shown in FIGS. 1 and 3, or computer system 900 shown and described in FIG. 9 below, the methods described herein may be executed or otherwise performed by other systems, or a combination of systems. Each block shown in the flowcharts described below may further represent one or more processes, methods, or subroutines, and one or more of the blocks may include machine-readable instructions stored on a non-transitory computer-readable medium and executed by a processor or other type of processing circuit to perform one or more operations described herein.

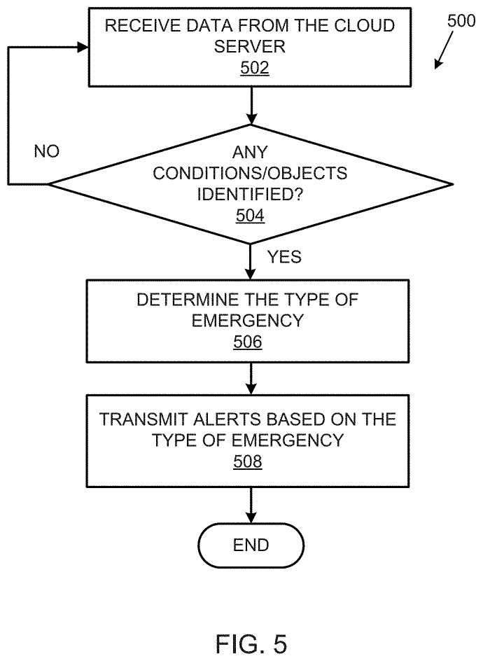

FIG. 5 shows a flowchart 500 of a method for remotely monitoring a premises such as the building 120 according to an example. The method may begin at 502 wherein the data 130 which may include images may be received at the cloud server 140 from the dual-purpose camera system 108. At 504, the existence of an emergency at the remotely monitored geographic location, i.e., the building 120 may be determined by analyzing the data 130 using the ML models 350 for object identification. Particular ML models may be trained to identify specific objects/conditions indicative of an emergency may be included in the ML models 350. For example, ML models trained for identifying fire or smoke, living beings or breakage (e.g., windows), etc. may be included. If no objects/conditions are detected by the ML models 350 at 504, the method may return to 502 to continue receiving data from the dual-purpose camera system 108. If any objects/conditions are identified at 504, it may imply that an emergency exists in the building 120.

Accordingly, a type of emergency may be determined at 506. For example, it may be determined if the emergency is a fire-related emergency or a non-fire emergency i.e., an emergency not related to fire such as but not limited to, flood, breakage, intruders, etc. For particular objects/conditions such as fire and smoke, further confirmation may be obtained from the IR sensor 410 at 506. In case further confirmation is obtained from analyzing the portion of the data 130 from the IR sensor 410, then one or more notifications/alerts may be transmitted at 508 based on the type of emergency. For example, an alert in addition to the alert 172 to the client device 162, may also be transmitted to public services such as a fire department in case the data 130 from the visible sensor 406 and the IR sensor 410 indicate a fire emergency. If at 506 if particular objects are detected, which may not require further confirmation or which may not be confirmed by the IR sensor 410 at 506, then an alert 172 only to the client device 162 may be transmitted at 508.

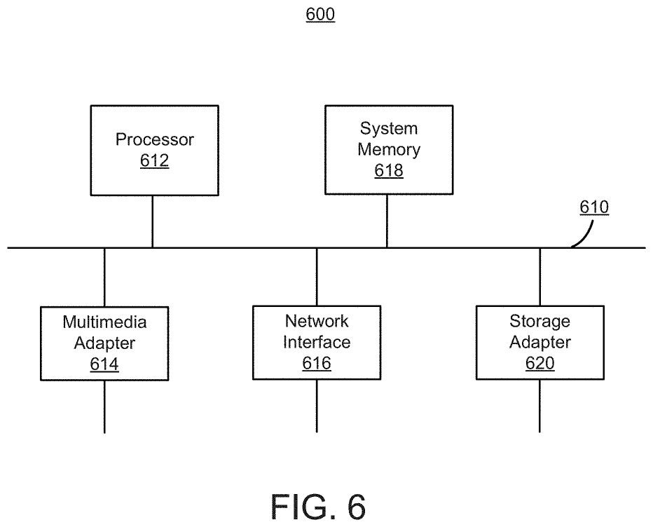

FIG. 6 illustrates a block diagram of a computer system 600 for data processing and object recognition, according to an example. The computer system 600 may be part of or any one of the user device 200 or the cloud server 140 or the client device 162 to perform the functions and features described herein. The computer system 600 may include, among other things, an interconnect 610, a processor 612, a multimedia adapter 614, a network interface 616, a system memory 618, and a storage adapter 620.

The interconnect 610 may interconnect various subsystems, elements, and/or components of the computer system 600. As shown, the interconnect 410 may be an abstraction that may represent any one or more separate physical buses, point-to-point connections, or both, connected by appropriate bridges, adapters, or controllers. In some examples, the interconnect 610 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1364 bus, or “firewire,” or other similar interconnection element.

In some examples, the interconnect 610 may allow data communication between the processor 612 and system memory 618, which may correspond to one or more of the memories 220 and 320. The system memory 618 may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 612 (which may correspond to the processor 210 or the processor 310) may be the central processing unit (CPU) of the computing device and may control the overall operation of the computing device. In some examples, the processor 612 may accomplish this by executing software or firmware stored in system memory 618 or other data via the storage adapter 620. The processor 612 may be, or may include, one or more programmable general-purpose or special-purpose microprocessors, digital signal processors (DSPs), programmable controllers, application-specific integrated circuits (ASICs), programmable logic device (PLDs), trust platform modules (TPMs), field-programmable gate arrays (FPGAs), other processing circuits, or a combination of these and other devices.

The multimedia adapter 614 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 616 may provide the computing device with an ability to communicate with a variety of remote devices over a network and may include, for example, an Ethernet adapter, a Fibre Channel adapter, and/or other wired- or wireless-enabled adapter. The network interface 616 may provide a direct or indirect connection from one network element to another, and facilitate communication and between various network elements.

The storage adapter 620 may connect to a standard computer-readable medium for storage and/or retrieval of information, such as a fixed disk drive (internal or external).

Many other devices, components, elements, or subsystems (not shown) may be connected in a similar manner to the interconnect 610 or via a network. Conversely, all of the devices shown in FIG. 6 need not be present to practice the present disclosure. The devices and subsystems may be interconnected in different ways from that shown in FIG. 6. Code to implement the present disclosure may be stored in computer-readable storage media such as one or more of system memory 618 or other storage. Code to implement the present disclosure may also be received via one or more interfaces and stored in memory. The operating system provided on computer system 600 may be MS-DOS®, MS-WINDOWS®, OS/2®, OS X®, IOS®, ANDROID®, UNIX®, Linux®, or another operating system.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” may be used herein to mean “serving as an example, instance, or illustration.” Any embodiment or design described herein as “example” may not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1.-7. (canceled)

8. A dual-purpose camera comprising:
an imaging lens;
a beam split cube to receive an incident light beam from an object through the imaging lens, the beam split cube comprising a surface to transmit a visible light component of the incident light beam and reflect an infrared (IR) component of the incident light beam;
a visible light sensor to receive the visible light component of the incident light beam transmitted through the surface of PA the beam split cube to capture visible images of the object; and
an infrared (IR) sensor to receive the IR component of the incident light beam reflected by the surface of the beam split cube to capture IR images of the object,
wherein the visible images and the IR images of the object captured by the dual-purpose camera are transmitted to a server,
wherein the server is to use a machine learning model with the visible images to identify the object, and use the machine learning model with the IR images to obtain confirmation regarding the object, and
wherein the machine learning model used with the IR images comprises an IR imaging based machine vision model.

9. The dual-purpose camera of claim 8, wherein the server is to:
determine existence of an emergency at a remote monitored location based on the visible images and the IR images, comprising determining a specific type of the emergency at the remote monitored location; and
transmit an alert to a client device.

10. The dual-purpose camera of claim 9, wherein the specific type of the emergency is at least one of fire and smoke.

11. The dual-purpose camera of claim 8, wherein the surface of the beam split cube is coated such that the IR component of the incident light beam is reflected, and the IR sensor is arranged below the coated surface of the beam split cube such that the reflected IR component of the incident light beam falls on the IR sensor.

12. The dual-purpose camera of claim 8, wherein a lens is attached to a prism of the beam split cube, and a combination of the lens and the prism generates a sharp IR image.

13. The dual-purpose camera of claim wherein the imaging lens comprises multiple lenses.

14.-20. (canceled)

21. A remote sensing security system comprising:
a dual-purpose camera comprising:
an imaging lens;
a beam split cube to receive an incident light beam from an object through the imaging lens, the beam split cube comprising a surface to transmit a visible light component of the incident light beam and reflect an infrared (IR) component of the incident light beam;
a visible light sensor to receive the visible light component of the incident light beam transmitted through the surface of the beam split cube to capture visible images of the object; and
an infrared (IR) sensor to receive the IR component of the incident light beam reflected by the surface of the beam split cube to capture IR images of the object; and
a server, communicatively coupled to the dual-purpose camera, to:
receive the visible images and the IR images of the object transmitted by the dual-purpose camera;
use a machine learning model with the visible images to identify the object; and
use the machine learning model with the IR images to obtain confirmation regarding the object, wherein the machine learning model used with the IR images comprises an IR imaging based machine vision model.

22. The remote sensing security system of claim 21, wherein the server is to:
determine existence of an emergency at a remote monitored location based on the visible images and the IR images, comprising determining a specific type of the emergency at the remote monitored location; and
transmit an alert to a client device.

23. The remote sensing security system of claim 22, wherein the specific type of the emergency is at least one of fire and smoke.

24. The remote sensing security system of claim 21, wherein the surface of the beam split cube is coated such that the IR component of the incident light beam is reflected, and
wherein the IR sensor is arranged below the coated surface of the beam split cube such that the reflected IR component of the incident light beam falls on the IR sensor.

25. The remote sensing security system of claim 21, wherein a lens is attached to a prism of the beam split cube, and a combination of the lens and the prism generates a sharp IR image.

26. The remote sensing security system of claim 21, wherein the imaging lens comprises multiple lenses.

27. A remotely security sensing method comprising:
providing a dual-purpose camera to capture an incident light beam from an object, the dual-purpose camera comprising:
an imaging lens;
a beam split cube to receive the incident light beam from the object through the imaging lens, the beam split cube comprising a surface to transmit a visible light component of the incident light beam and reflect an infrared (IR) component of the incident light beam;
a visible light sensor to receive the visible light component of the incident light beam to capture visible images of the object; and
an infrared (IR) sensor to receive the IR component of the incident light beam to capture IR images of the object; and
receiving, by a processor of a server, the visible images and the IR images of the object transmitted by the dual-purpose camera;
identifying, by the processor, the object using a machine learning model with the visible images; and
confirming, by the processor, the object using the machine learning model with the IR images, wherein the machine learning model used with the IR images comprises an IR imaging based machine vision model.

28. The remotely security sensing method of claim 27, further comprising:
determining, by the processor, existence of an emergency at a remote monitored location based on the visible images and the IR images, comprising determining a specific type of the emergency at the remote monitored location; and
transmitting, by the processor, an alert to a client device.

29. The remotely security sensing method of claim 28, wherein the specific type of the emergency is at least one of fire and smoke.

30. The remotely security sensing method of claim 27, wherein the surface of the beam split cube is coated such that the IR component of the incident light beam is reflected, and wherein the IR sensor is arranged below the coated surface of the beam split cube such that the reflected IR component of the incident light beam falls on the IR sensor.

31. The remotely security sensing method of claim 27, wherein a lens is attached to a prism of the beam split cube, and a combination of the lens and the prism generates a sharp IR image.

32. The remotely security sensing method of claim 27, wherein the imaging lens comprises multiple lenses.
